(19) United States
(12) Patent Application Publication
(10) Pub. No.: US 2015/0270597 A1
(43) Pub. Date: Sep. 24, 2015

(54) Spiral Antenna

(71) Applicant: Google Inc., Mountain View, CA (US)

(72) Inventors: Douglas Blake Kough, San Jose, CA (US); Menno Marringa, San Francisco, CA (US); Susan Marie Chikes, Cupertino, CA (US)

(73) Assignee: Google Inc., Mountain View, CA (US)

(21) Appl. No.: 14/219,237

(22) Filed: Mar. 19, 2014

(51) Int. Cl. H01Q 1/22; H01Q 9/16; H01Q 1/36

(52) U.S. Cl. CPC H01Q 1/22; H01Q 1/36; H01Q 9/16

(57) ABSTRACT

Systems and techniques are provided for a spiral light antenna. An antenna element may include a first curved element disposed orthogonally to a second curved element. The first curved element and the second curved element may be connected at a connection point at a center of the first curved element and a center of the second curved element. The antenna element may have rotational symmetry and origin symmetry though the connection point but not linear symmetry. The first curved element may be longer than the second curved element. A feed may be connected to the antenna element at the connection point perpendicular to the plane of the antenna element. The first curved element may be inductive, and the second curved element may be capacitive. The antenna element may be disposed at the front of a light bulb and the feed may extend towards the back of the light bulb.

### BACKGROUND

Light bulbs used in home automation systems, such as Light Emitting Diode (LED) floodlights and spotlights, are often recessed into metal cans for decorative purposes. The metal cans may include home automation hardware, such as radios and antennas for sending data from the light bulb and receiving control signals for the light bulb, to allow the light bulb to be operated by the home automation system through the metal can or similar enclosure or housing.

The metal cans may impede the radiation of radio frequency (RF) signals used by the home automation hardware installed in the metal cans, as the metal can may be below the dominant mode cutoff frequency for the radio and antenna used by the home automation hardware. The antennas may be Inverted-F Antennas and Planar Inverted-F Antennas. Evanescent modes and fringing fields may be used in the creation of radiating modes, but these may be inefficient.

### BRIEF SUMMARY

According to an embodiment of the disclosed subject matter, an antenna element may include a first curved element disposed orthogonally to a second curved element, where the first curved element and the second curved element may be connected at a connection point at a center of the first curved element and a center of the second curved element, the antenna element may have rotational symmetry and origin symmetry though the connection point but may not have linear symmetry, and the first curved element may be longer than the second curved element. A feed may be connected to the antenna element at the connection point perpendicular to the plane of the antenna element.

The antenna element may be for a monopole antenna. The feed may be an unbalanced feed for a monopole antenna. The first curved element may be inductive. The second curved element may be capacitive. A signal carried by the feed may to cause the antenna element to emit circularly polarized radiation. The first curved element and the second curved element may be S-shaped. The first curved element and the second curved element may be wire having a thickness not more than 30 gauge. The antenna element may be disposed at the front of a light bulb and the feed may extend towards the back of the light bulb. A radio may be disposed within the light bulb and connected to the feed. The radio may send and receive signals using the antenna element. The radio may be connected to home automation hardware disposed within the light bulb. The light bulb may include a light diffusing cover, and the antenna element may be disposed on the top of, inside of, or on the underside of the light diffusing cover. A monopole spiral light antenna may include the antenna element and the feed.

An antenna element may include a first dipole element and a second dipole element, where the first dipole element and second dipole elements each include a half first curved element connected at a first end to a first end of a half second curved element at a connection point, the first dipole element and second dipole element may be electrically separated in the antenna element, the first half curved element may be longer than the second half curved element, and the antenna element may have rotational symmetry and origin symmetry though a point located in the separation between the first dipole element and the second dipole element but may not have linear symmetry. A first half feed may be connected to the connection point of the first dipole element, and a second half feed may be connected to the connection point of the second dipole element.

A light bulb may include lighting elements. A spiral light antenna including a feed and an antenna element may be disposed within the light bulb, where the antenna element is disposed at the front of the light bulb in front of the lighting elements. A radio may be disposed within the light bulb and connected to the feed of the spiral light antenna.

Systems and techniques disclosed herein may allow for a spiral light antenna. Additional features, advantages, and embodiments of the disclosed subject matter may be set forth or apparent from consideration of the following detailed description, drawings, and claims. Moreover, it is to be understood that both the foregoing summary and the following detailed description include examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example top view of a monopole spiral light antenna according to an implementation of the disclosed subject matter.

FIG. 2 shows an example top view of a dipole spiral light antenna according to an implementation of the disclosed subject matter.

FIG. 3 shows an example perspective view of a monopole spiral light antenna according to an implementation of the disclosed subject matter.

FIG. 4 shows an example perspective view of a dipole spiral light antenna according to an implementation of the disclosed subject matter.

FIG. 5 shows an example metal can with a light bulb including a spiral light antenna according to an implementation of the disclosed subject matter.

FIG. 6 shows an example cutaway view of a light bulb with a spiral light antenna according to an implementation of the disclosed subject matter.

FIG. 7 shows an example top view of a light bulb with a spiral light antenna according to an implementation of the disclosed subject matter.

FIG. 8 shows an example exploded view of a light diffusing cover, lighting elements, and spiral light antenna from a light bulb according to an implementation of the disclosed subject matter.

FIG. 9 shows home automation hardware according to an embodiment of the disclosed subject matter.

### DETAILED DESCRIPTION

A spiral light antenna may allow for better radiation of signals from a light bulb used in a home automation system. In an implementation of the disclosed subject matter, a spiral light antenna may include two curved elements arranged orthogonally. The curved elements may be, for example, S-shaped, and may be arranged so that the curved elements form a part of a spiral, and so that the spiral light antenna exhibits rotational symmetry and symmetry around the intersection of the curved elements, but not linear symmetry. The rotational symmetry may be of the 2^{nd} order. The curved elements may be made of any suitable material of any suitable size and shape for an antenna that may be thin enough not to cause a shadow in the light emitted from the light bulb, such as, for example, 30 or 36 gauge wire.

The spiral light antenna may be installed in a light bulb, such as, for example, an LED floodlight or spotlight, used in a home automation system. The spiral light antenna may be installed at the front of the light bulb, for example, on top of, in, or just under a light diffusing cover for the light bulb, and may extend to cover as much of the front of the light bulb as is feasible. The lighting elements, such as, for example, individual LEDs, may be located behind the spiral light antenna in the light bulb. The spiral light antenna may be thin enough that the spiral light antenna does not cast a shadow in the light from the lighting elements as viewed outside the light bulb. For example, a 30- to 36-gauge wire may be thin enough that no visible shadow is created by the presence of the wire in or on the bulb when used at standard distances and arrangements common to home and office lighting systems. In other configurations, a thicker wire may be used to provide aesthetically-pleasing lighting effects, such as decorative patterns or shadow, when the lighting element is activated. A home automation system may be able to communicate with home automation hardware in the light bulb through a radio in the light bulb connected to the spiral light antenna by a feed. The light bulb may send data, such as status data, and receive data, such as control commands, to and from the home automation system. The light bulb with the spiral light antenna may be installed in a metal can, for example, for decorative purposes, with the spiral light antenna near the opening of the metal can. This may allow the spiral light antenna to operate more efficiently, receiving and transmitting RF signals that are not blocked by the body of the metal can.

One of the two curved elements of the spiral light antenna may be longer than the other curved element. The longer of the curved elements be slightly longer than the resonance frequency of the spiral light antenna, while the shorter of the curved elements may be slightly shorter the resonance frequency of the spiral light antenna. This may cause the shorter of the curved elements to exhibit more capacitive properties, while the longer of the two curved elements may exhibit more inductive properties. The induction and capacitance may be phased so that the two curved elements radiate equal orthogonal amplitudes in phase quadrature. For example, the linear components fed into the spiral light antenna from the radio may be degraded into two vectors delayed by 90 degrees. This may result in circular polarization of the RF signal emitted by the spiral light antenna. The circularly polarized RF signal may be received by a linear antenna that is part of the home automation system regardless of the position of the linear antenna. For example, a wireless router with home automation radios may serve as a gateway to the home automation system, allowing other wireless devices connected to the wireless router to control devices such as light bulbs equipped with home automation hardware, and may include linear antennas.

The spiral light antenna may be a monopole or dipole antenna. In a monopole spiral light antenna, the feed may connect to the center of the spiral antenna, where the curved elements intersect, and traverse through the center of the light bulb to the radio and other home automation hardware in the light bulb. The curved elements may be connected directly to form an antenna element of the monopole spiral light antenna. In a dipole spiral light antenna, the curved elements may each be split, with each half of the longer curved element connected to a half of the shorter curved element, creating two dipole elements. The feed for the dipole spiral light antenna may be split with each half of the feed connecting to one of the dipole elements at the point where the longer curved element and shorter curved element of the dipole element meet. The dipole elements may be connected indirectly, for example, using an insulator, to form an antenna element of the dipole spiral light antenna element.

The monopole spiral light antenna may be unbalanced and not need a balun. The radiation from the monopole spiral light antenna may be more directed, so the monopole spiral light antenna may have gain a 3 dB higher than the gain of the dipole spiral light antenna.

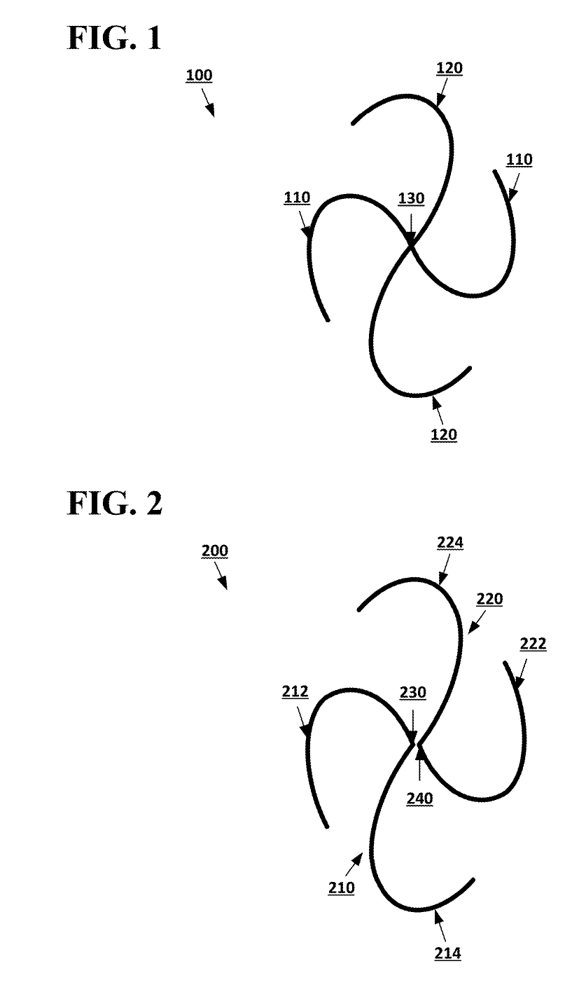

FIG. 1 shows an example top view of a monopole spiral light antenna according to an implementation of the disclosed subject matter. A monopole spiral light antenna 100 may include a short curved element 110 and a long curved element 120 (not depicted to scale), which may be S-shaped curves connected together orthogonally at their centers, forming an antenna element. A feed 130 may be connected to the center of the antenna element of the monopole spiral light antenna 100, at the location where the short curved element 110 and long curved element 120 are connected. The antenna element may exhibit rotational symmetry and origin symmetry at the intersection of the curved elements, which may be the connection point for the feed 130, but not linear symmetry. That is, the shape of the antenna may be invariant when rotated through, for example, 180 degrees, and/or may be symmetric about the connection point for the feed 130.

The short curved element 110 and long curved element 120 may be made of any suitable material for an antenna, such as, for example, 36 or 30 gauge wire, and may have any suitable amount of curvature. The long curved element 120 may be slightly longer than the resonance frequency of the monopole spiral light antenna 100. For example, the long curved element 120 may be slightly longer than a multiple of one quarter wavelength of the resonance frequency of the monopole spiral light antenna 100. This may cause the long curved element 120 to exhibit inductive properties. The short curved element 110 may be slightly shorter than the resonance frequency of the monopole spiral light antenna 100. For example, the short curved element 110 may be slightly shorter than a multiple of one quarter wavelength of the resonance frequency of the monopole spiral light antenna 100. This may cause the short curved element 110 to exhibit capacitive properties.

The RF signal emitted by the monopole spiral light antenna 100 may be circularly polarized. The inductance of the long curved element 120 and the capacitance of the short curved element 110 may be phased so that the long curved element 120 and the short curved element 110 radiate equal orthogonal amplitudes in phase quadrature, resulting in a circularly polarized RF signal.

The feed 130 may extend back from the monopole spiral light antenna 100 to connect to a radio which may use the monopole spiral light antenna 100 to transmit and receive signals, for example, as part of a home automation system. The linear components of the feed signal may be degraded into two vectors delayed by 90 degrees to create the circularly polarized RF radiation. The feed 130 may include two conductors, which may be any suitable conductors in any suitable configuration for carrying electricity to and from the monopole spiral light antenna 100.

FIG. 2 shows an example top view of a dipole spiral light antenna according to an implementation of the disclosed subject matter. A dipole spiral light antenna 200 may include a first dipole element 210 and a second dipole element 220. The first dipole element 210 may include a half short curved element 212 and a half long curved element 214, which may be, for example, half of the short curved element 110 and half of the long curved element 120, respectively, and may be made of similar materials, such as for example, 36 or 30 gauge wire. The half short curved element 212 and the half long curved element 214 may be connected at their respective ends and arranged such that the angle of the intersection is approximately 90 degrees and the non-connected ends cannot be connected by a straight line in the plane of the first dipole element 210 without crossing either the half short curved element 212 or the half long curved element 214. The second dipole element 220 may include a half short curved element 222 and a half long curved element 224, which may be similar to, and arranged similarly to, the half short curved element 212 and the half long curved element 214. The first dipole element 210 and second dipole element 220 may each be made from a continuous wire bent at approximately 90 degrees at the location of the connection between the half long curved elements 214 and 224 and the half short curved elements 212 and 222.

The combined length of the half long curved element 214 and the half long curved element 224 may be slightly longer than the resonance frequency of the dipole spiral light antenna 200. For example, the combined length may be slightly longer than a multiple of one quarter wavelength of the resonance frequency of the dipole spiral light antenna 200. This may cause the combination of the half long curved element 214 and the half long curved element 224 to exhibit inductive properties. The combined length of the half short curved element 212 and the half short curved element 222 may have a resonance frequency slightly shorter than the resonance frequency of the dipole spiral light antenna 200. For example, the combined length may be slightly shorter than a multiple of one quarter wavelength of the resonance frequency of the spiral antenna 100. This may cause the combination of the half short curved element 212 and the half short curved element 222 to exhibit capacitive properties. The RF signal emitted by the dipole spiral light antenna 200 may be circularly polarized similarly to the RF signal emitted by the monopole spiral light antenna 100.

A half feed 230 may connect to the first dipole element 210 at the connection between the half short curved element 212 and the half long curved element 214. The half feed 230 may be half of the feed 130. For example, the half feed 230 may be the center wire of a coaxial cable. A half feed 240 may connect to the second dipole element 220 at the connection between the half short curved element 222 and the half long curved element 224. The half feed 240 may be the other half of the feed 130. For example, the half feed 230 may be the shielding of the coaxial cable. The linear components carried through the half feed 230 and the half feed 240 may be degraded similarly to the linear components carried through the feed 130.

The first dipole element 210 and the second dipole element 220 may be connected together to form an antenna element for the dipole spiral antenna 200. A suitable insulator may be used to connect the first dipole element 210 and the second dipole element 220, so that the first dipole element 210 and the second dipole element 220 may be only be electrically connected through the half feed 230 and the half feed 240.

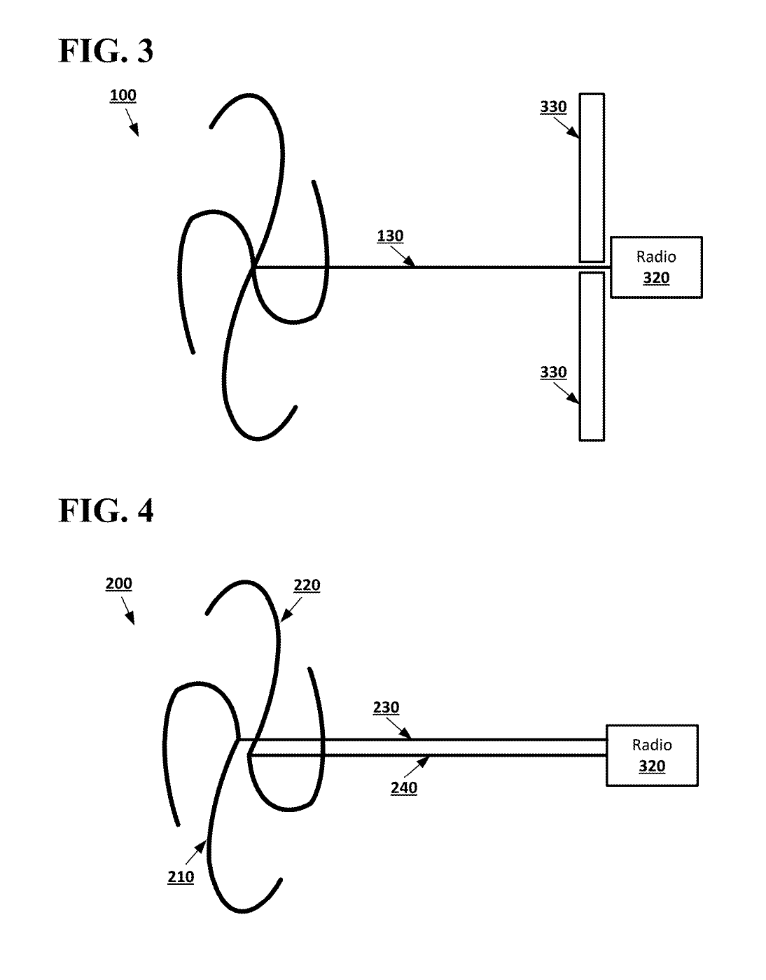

FIG. 3 shows an example perspective view of a monopole spiral light antenna according to an implementation of the disclosed subject matter. The feed 130 may extend back from the center of the monopole spiral light antenna 100 and connect to a radio 320. The radio 320 may be any suitable radio for wireless RF communications, such as, for example, a Wi-Fi, Bluetooth, or cellular radio. The radio 320 may transmit and receive signals using the monopole spiral antenna 100. The feed 130 may also pass through a ground plane 330, which may be any suitable ground plane for the operation of a monopole antenna. The feed 130 may need to be relatively long compared to the dimensions of the monopole spiral light antenna 100.

FIG. 4 shows an example perspective view of a dipole spiral light antenna according to an implementation of the disclosed subject matter. The half feed 230 may extend back from the first dipole element 210, and the half feed 240 may extend back from the second dipole element 220. The half feed 230 and the half feed 240 may connect to the radio 320. The half feed 230 and the half feed 240 may be relatively long compared to the dimensions of the dipole spiral light antenna 200.

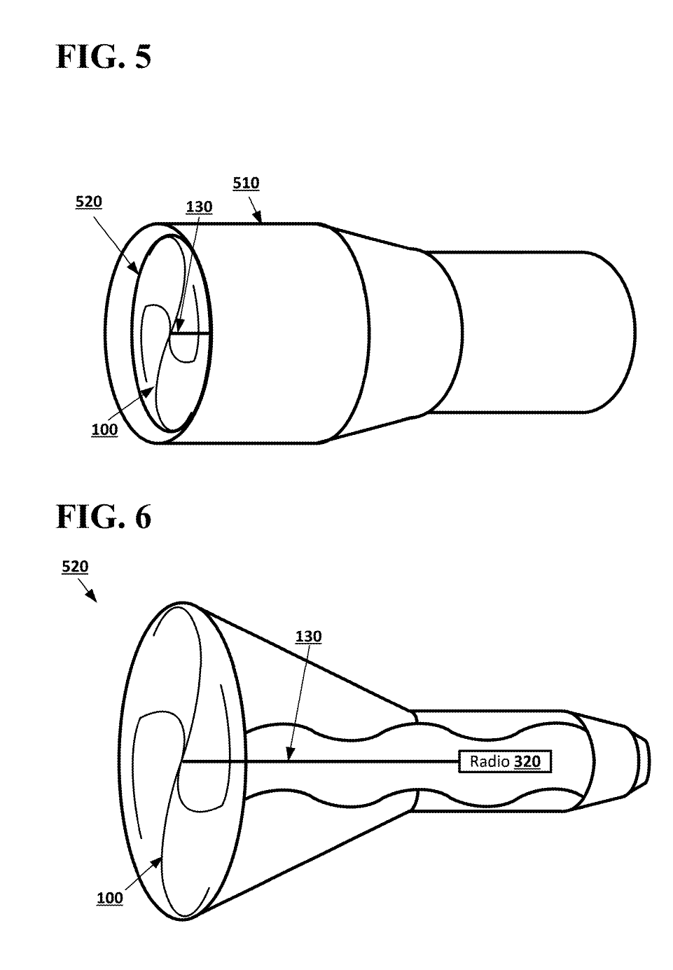

FIG. 5 shows an example metal can with a light bulb including a spiral light antenna according to an implementation of the disclosed subject matter. A light bulb 520 may be installed into a metal can 510. The light bulb 520 may be, for example, an LED floodlight, spotlight, or other recessed lighting fixture, or more generally may be any conventional lighting fixture. The fixture itself may be suitable for use with a home automation system, or may be a conventional lighting fixture that can be made usable with a home automation system through use of the subject matter disclosed herein. The metal can 510 may be, for example, a decorative metal can used to mount the light bulb 520, for example, as in tracked lighting or recessed lighting.

A spiral light antenna may be installed in the light bulb 520. For example, the monopole spiral light antenna 100 may be installed in the light bulb 520, with the short curved element 110 and the long curved element 120 near the front of the light bulb 520 and the feed 130 extending back through the center of the light bulb 520. The positioning of the short curved element 110 and the long curved element 120 may allow them to be near the opening of the metal can 510 when the light bulb 520 is installed in the metal can 510. This may allow for the more efficient operation of the monopole spiral light antenna 100, as RF signals may be transmitted and received through the opening in the metal can 510, with the impedance of the RF signals by the body of the metal can 510 reduced. The material used to construct the short curved element 110 and the long curved element 120 may be thin enough that light from the light bulb 520 is not blocked in a way that causes the monopole spiral light antenna 100 to cast a shadow visible to the human eye under standard conditions outside of the light bulb 520. The material may also be thin enough that the short curved element 110 and the long curved element 120 are not visible within the light bulb 520 to the average human eye.

FIG. 6 shows an example cutaway view of a light bulb with a spiral light antenna according to an implementation of the disclosed subject matter. The feed 130 of the monopole spiral light antenna 100 may extend through the center of the light bulb 520 to the radio 320, which may be at the base of the light bulb 520. The radio 320 may be connected to other home automation hardware, which may also be at the base of the light bulb 520, such as, for example, controllers capable of adjusting the light output of the light bulb 520. Signals sent and received by the radio 320 may be used to control the light bulb 520 and transmit data about the light bulb 520 as part of the home automation system.

The short curved element 110 and the long curved element 120 of the monopole spiral light antenna 100 may be installed in the light bulb 520 in any suitable manner to allow the sending and receiving of RF signals through the front of the light bulb 520 and the opening of the metal can 510. For example, the short curved element 110 and the long curved element 120 may be installed in a light diffusing cover, in a dome, or otherwise embedded within the surface of the light bulb 520.

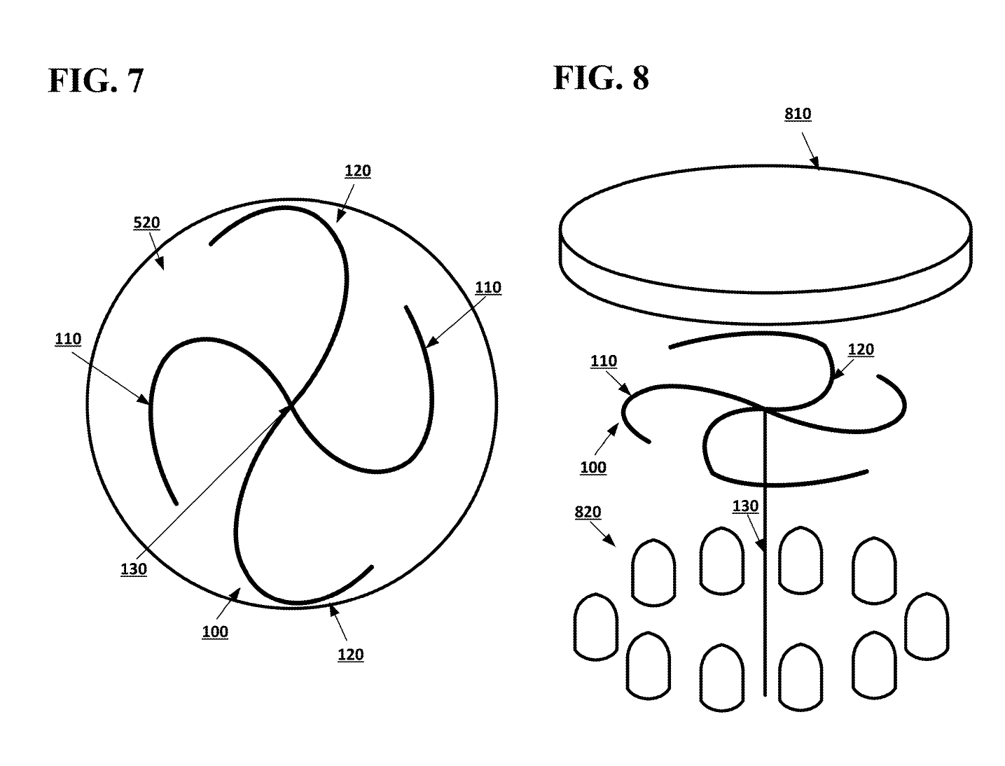

FIG. 7 shows an example top view of a light bulb with a spiral light antenna according to an implementation of the disclosed subject matter. A spiral light antenna, such as the monopole spiral light antenna 100, may be sized to take up as much of the available volume at the front of the light bulb 520 as possible. For example, the long curved element 120 may extend to or near the edge of the of the front of the light bulb 520 while still being slightly longer than a multiple of one quarter wavelength of the resonance frequency of the monopole spiral light antenna 100. The short curved element 110 may extend as close to the edge as possible while still being slightly shorter than a multiple of one quarter wavelength of the resonance frequency of the monopole spiral light antenna 100.

FIG. 8 shows an example exploded view of a light diffusing cover, lighting elements, and spiral light antenna from a light bulb according to an implementation of the disclosed subject matter. The monopole spiral light antenna 100 may be installed in the light bulb 520 with the short curved element 110 and the long curved element 120 located on, inside of, or just underneath a light diffusing cover 810. The light diffusing cover 810 may be a cover on the front of the light bulb 520 for diffusing light from one or more lighting elements 820, which may be discrete LEDs or other light sources. The light diffusing cover 810 may be made of any suitable material, such as, for example, transparent plastic, for not blocking light from the lighting elements 820 while also not impeding RF signals from being sent and received by the monopole spiral light antenna 100. The lighting elements 820 may be installed in the light bulb 520 behind the light diffusing cover 810 and the short curved element 110 and the long curved element 120 of the monopole spiral antenna 100. The feed 130 may run in between individual lighting elements 820 to the back of the light bulb 520.

In some instances, a spiral light antenna such as, for example, the monopole spiral light antenna 100 or the dipole spiral light antenna 200, may be used in devices other than the light bulb 520. For example, the monopole spiral light antenna 100 may be installed in flat screen televisions, such as a Plasma, LCD, LED, or OLED television. The short curved element 110 and the long curved element 120 may be installed on the thin edge of the television, while the feed 130 may run behind and parallel to the screen of the television. This may allow the feed 130 to have an appropriate length. The monopole spiral antenna 100 may also be installed in any other suitable devices that use wireless RF signals, such as, for example, wireless routers, wireless adapters for computing devices, and mobile devices such as tablets and cellular phones.

In some configurations, the antenna may be used to cast shadows intentionally, such as by having thicker elements than previously described, and/or different lens and diffuser configurations that provide specific shapes or arrangements. For example, the antenna elements may be arranged in a flower shape, such that when the light is turned on it provides an illumination that includes the flower shape as a shadow within the illuminated area.

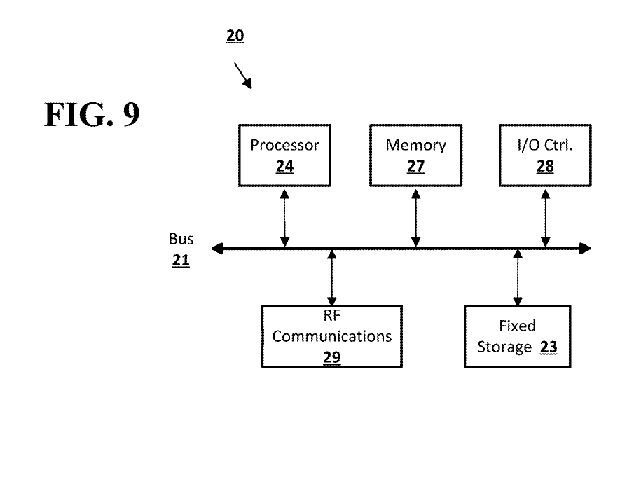

Embodiments of the presently disclosed subject matter may be implemented in and used with a variety of component and network architectures. FIG. 9 is an example home automation hardware system 20 suitable for implementing embodiments of the presently disclosed subject matter. The home automation hardware 20 includes a bus 21 which interconnects major components of the home automation hardware 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, and other components known in the art to use in or in conjunction with general-purpose computing systems and specifically with home automation hardware systems

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the home automation hardware 20 are generally stored on and accessed via a computer readable medium, such as the fixed storage 23 and/or the memory 27, or the like.

Each component shown may be integral with the home automation hardware system 20 or may be separate and accessed through other interfaces. Other interfaces, such as a RF communications 29, may provide a connection to remote systems and devices via a wireless local- or wide-area network connection, proprietary network connections, or the like. For example, the RF communications 29 may allow the home automation hardware 20 to communicate with other computers via one or more local, wide-area, or other networks. The RF communications 29 may include a radio suitable for communicating using RF emissions, and a network interface for interacting with other network systems, such as a home automation network. The input/output controller 28 may be suitable for controlling the light bulb 520 based on commands received through the RF communications 29, from, for example, other equipment in the home automation network.

Many other devices or components (not shown) may be connected in a similar manner, such as document scanners, digital cameras, auxiliary, supplemental, or backup systems, or the like. Conversely, all of the components shown in FIG. 9 need not be present to practice the present disclosure. The components can be interconnected in different ways from that shown. The operation of a computer such as that shown in FIG. 9 is readily known in the art and is not discussed in detail in this application. Code to implement the present disclosure can be stored in computer-readable storage media such as one or more of the memory 27, fixed storage 23, remote storage locations, or any other storage mechanism known in the art.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. An apparatus comprising:
an antenna element comprising a first curved element disposed orthogonally to a second curved element, wherein the first curved element and the second curved element are connected at a connection point at a center of the first curved element and a center of the second curved element, the antenna element has rotational symmetry and origin symmetry though the connection point but does not have linear symmetry, and the first curved element is longer than the second curved element; and
a feed connected to the antenna element at the connection point perpendicular to the plane of the antenna element

2. The apparatus of claim 1, wherein the antenna element is for a monopole antenna.

3. The apparatus of claim 1, wherein the feed is an unbalanced feed for a monopole antenna.

4. The apparatus of claim 1, wherein the first curved element is inductive.

5. The apparatus of claim 1, wherein the second curved element is capacitive.

6. The apparatus of claim 1, wherein a signal carried by the feed is adapted to cause the antenna element to emit circularly polarized radiation.

7. The apparatus of claim 1, wherein the first curved element and the second curved element are S-shaped.

8. The apparatus of claim 1, wherein each of the first curved element and the second curved element comprise a wire having a thickness not more than 30 gauge.

9. The apparatus of claim 1, further comprising a light bulb, wherein the antenna element is disposed at the front of the light bulb and the feed extends towards the back of the light bulb.

10. The apparatus of claim 9, further comprising a radio disposed within the light bulb and connected to the feed, wherein the radio is adapted to send and receive signals using the antenna element.

11. The apparatus of claim 10, wherein the radio is further connected to home automation hardware disposed within the light bulb.

12. The apparatus of claim 9, wherein the light bulb comprises a light diffusing cover, and wherein the antenna element is disposed at one of: on the top of, inside of, and on the underside of the light diffusing cover.

13. The apparatus of claim 1, wherein a monopole spiral light antenna comprises the antenna element and the feed.

14. An apparatus comprising:
an antenna element comprising a first dipole element and a second dipole element, wherein the first dipole element and second dipole elements each comprise a half first curved element connected at a first end to a first end of a half second curved element at a connection point, the first dipole element and second dipole element are electrically separated in the antenna element, the first half curved element is longer than the second half curved element, and the antenna element has rotational symmetry and origin symmetry though a point located in the separation between the first dipole element and the second dipole element but does not have linear symmetry;
a first half feed connected to the connection point of the first dipole element; and
a second half feed connected to the connection point of the second dipole element.

15. The apparatus of claim 14, wherein the antenna element is a dipole antenna.

16. The apparatus of claim 14, wherein the feed is a balanced feed for a dipole antenna.

17. The apparatus of claim 14, wherein the combination of the two half first curved elements is inductive.

18. The apparatus of claim 14, wherein the combination of the two half second curved elements is capacitive.

19. The apparatus of claim 14, wherein a signal carried by the first half feed and the second half feed is adapted to cause the antenna element to emit circularly polarized radiation.

20. The apparatus of claim 14, wherein the combination of the two half first curved elements and the combination of the two half second curved elements are S-shaped.

21. The apparatus of claim 14, wherein each of the half first curved elements and the half second curved elements comprise a wire having a thickness not more than 30 gauge.

22. The apparatus of claim 14, further comprising a light bulb, wherein the antenna element is disposed at the front of the light bulb and the first half feed and the second half feed extend towards the back of the light bulb.

23. The apparatus of claim 22, further comprising a radio disposed within the light bulb and connected to the first half feed and the second half feed, wherein the radio is adapted to send and receive signals using the antenna element.

24. The apparatus of claim 23, wherein the radio is further connected to home automation hardware disposed within the light bulb.

25. The apparatus of claim 22, wherein the light bulb comprises a light diffusing cover, and wherein the antenna element is disposed at one of: on the top of, inside of, and on the underside of the light diffusing cover.

26. The apparatus of claim 14, wherein a dipole spiral light antenna comprises the antenna element, the first half feed, and the second half feed.

27. The apparatus of claim 14, wherein the first dipole element is formed from a first continuous wire bent at the connection point, and the second dipole element is formed from a second continuous wire bent at the connection point.

28. An apparatus comprising:
a light bulb comprising lighting elements;
a spiral light antenna comprising a feed and an antenna element disposed within the light bulb, wherein the antenna element is disposed at the front of the light bulb in front of the lighting elements; and
a radio disposed within the light bulb and connected to the feed of the spiral light antenna.

29. The apparatus of claim 28, further comprising home automation hardware disposed within the light bulb and connected to the radio, wherein the home automation hardware is adapted to control the light bulb.

30. The apparatus of claim 28, wherein the lighting elements are light emitting diodes.

31. The apparatus of claim 28, further comprising a metal can with an opening at one end, wherein the light bulb is disposed inside of the metal can such that the antenna element of the spiral light antenna is disposed towards the opening of the metal can.

32. The apparatus of claim 28, further comprising a light diffusing cover disposed at the front of the light bulb in front of the lighting elements, and wherein the antenna element is disposed at one of: on top of, inside of, and on the underside of the light defusing cover.

33. The apparatus of claim 27, wherein the antenna element does not cause the lighting elements to cast a visible shadow of the antenna element.
